(19) United States
(12) Patent Application Publication
(10) Pub. No.: US 2003/0002486 A1
(43) Pub. Date: Jan. 2, 2003

(54) Telephone central office switch interface with messaging channel for integrating the PSTN with the Internet

(76) Inventor: Harry E. Emerson III, Succasunna, NJ (US)

Correspondence Address: Ernest D. Buff, Ernest D. Buff & Associates, LLC, 245 South Street, Morristown, NJ, 07960, US

(21) Appl. No.: 10/177,792

(22) Filed: Jun. 20, 2002

Related U.S. Application Data
(60) Provisional application No. 60/301,758, filed on Jun. 28, 2001.

(51) Int. Cl. H04L 12/66

(52) U.S. Cl. 370/352; 379/88.17

(57) ABSTRACT

Integration of the Internet with the Public Switched Telephone Network (PSTN) is facilitated for Voice over IP communications by incorporating an enhanced Voice over IP interface device with a messaging communications link to a telephone central office switching system. The communications link carries call setup, telephone number, and IP address messages to and from the switching system. Communications are facilitated by enabling messaging communications from the telephone central office switching system to individual devices.

This application claims the benefit of U.S. provisional patent application Serial No. 60/301,758, filed Jun. 28, 2001.

### BACKGROUND OF THE INVENTION

1. Field of the Invention

The present invention relates to the Internet and the Public Switched Telephone Network (PSTN); and more specifically to the integration of the Internet with the PSTN in such a fashion that systems, services, and devices on either can communicate with systems, services, and devices on the other, and that in doing so, the full benefit and unique characteristics of either network are available to these communications.

2. Description of the Prior Art

The Internet and the PSTN constitute discrete, independent networks from an architectural and operational perspective. Much is written about both networks, especially in terms of their architecture and operation. Consequently, the specification provided herein does not reconstruct that information other than providing general background information. The term “Internet” is commonly understood and used throughout the specification and claims in a conventional way. The Internet, in general, is an assemblage of interconnected routers that provide data transport services for server computers and user devices—typically PCs. The interconnection between routers is provided by private line data circuits, the main lines of which constitutes the Internet “backbone”. Internet Service Providers (ISPs) provide access to the Internet via dial up telephone lines with modems, and via dedicated arrangements such as T-1 circuits, cable modems on cable-TV systems, and DSL (Digital Subscriber Line) service.

The Internet is designed according to the Internet Protocol (IP) which provides detailed specifications for the construction, addressing, and routing of data packets (occasionally referred to as “messages” in this document). (The term “Internet Protocol” also is used loosely to refer to dozens of related protocols that are used in the Internet.) IP addresses are expressed as a series of digits separated by “dots” (periods), in the form XXX.XXX.XXX.XXX where XXX can be a number from 0 to 255. IP addresses provide a similar function on the Internet as telephone numbers provide on the PSTN. A communication with an Internet device can be established by sending a message addressed to the IP address of that device. Every device capable of communicating on the Internet has an IP address assigned to it, either permanently, or dynamically as needed. IP addresses in some environments are replaced with a proxy address; for purposes of this document, the term “IP address” shall refer to an actual IP address, or a proxy or other identifier translatable into an actual IP address. In some of these arrangements, the IP address may be indirectly associated with the Integrated Device. For example, in a wireless handset arrangement, the provider's complex might provide Internet connections for wireless handsets on a proxy basis wherein the complex keeps track of IP number assignments used for each handset, but communicates with each handset based on a serial number or other unique identifying scheme. The same goal is accomplished, i.e. an Internet capable handset gets its own IP address, but with one level of indirection. In other arrangements proxies or agents act on behalf of a client system and substitute the proxy's IP addresses for the addresses of the client devices—in these arrangements the combination of the proxy address and the original client system address resolve to provide a unique IP address for each client system. Internet data packets contain the IP address of both the sending system and receiving system (the source and destination, respectively). Since IP messages always contain the IP addresses of both the sending and destination device, when a device receives an Internet message from a sending device, it will then possess the IP address of the sender and can send messages in reply. The two devices can then engage in a communication across the Internet since each has the IP address of the other.

Routers have internal tables that provide routing instructions which relate IP addresses to the available data circuits and access lines. A router functions by reading the destination address in a data packet, and then forwarding the data packet on one of its data circuits or access lines according to the rules of the routing tables. A data packet gets forwarded from one router to another, pinballing its way across the Internet until it reaches a router that is connected to the destination system.

The term “Public Switched Telephone Network”, or PSTN, as used herein means the national and international telephone network, actuated when a user dials a telephone number associated with any other phone, causes it to ring, and if answered, is enabled to carry on a voice communication (or, more properly, a “voice grade” communication) with the person (or system) at the remote location. Just as the Internet is comprised of an aggregation of interconnected routers, the PSTN is comprised of an aggregation of interconnected local and long distance telephone switching systems. The local switching systems, referred to as telephone company (telco) central offices (CO), provide telephone subscriber services in a geographic area.

As used herein, the term “telephone central office switching system” refers generically to a class of systems, typically owned by the operating telephone company in any given area, which provide “local” telephony services to telephone subscribers in that area. Generally, the operating telephone company provides the “local loop” cabling and wiring from its central office to the physical location of each of its subscribers (a “telephone circuit”, or a “line”). A telephone central office might house several switching systems of this class, each serving up to 100,000 subscribers or more. The central office represents the hub of a wheel having thousands of spokes, each spoke being a physical pair of wires providing telephone service to a subscriber in that area. Subscribers in any given area are provided service by the central office situated in the center of the area. Outside that area the wires home to other similarly situated central offices. The telephone company connects the telephone circuit of a subscriber to an access connection on the switching system, and assigns a telephone number to that circuit. In operation, the switching system (or just “switch”) provides battery voltage on the phone line, sends dial tone to the subscriber line when the subscriber's phone goes off hook, receives the dialed digits, and then routes the call according to its internal instructions based on the called number.

Common manufactured switching systems of this class include the Lucent Technologies 5ESS, and the Nortel DMS100. All telephone central office-switching systems around the world are interconnected by “trunk” circuits that carry voice or voice grade telephone calls between systems, and most (if not all) such systems are also interconnected by a messaging network referred to as CCS/SS7 (Common Control System/Signaling System 7), or just SS7. Long distance calls to telephones outside of the area served by the local telephone company are typically routed to a long distance carrier, such as AT&T, MCI, or Sprint in the USA. The telephone central office switches connect via trunking and messaging circuits to a class of switching system referred to as a “toll switch”, such as the Lucent Technologies 4ESS, operated by a long distance carrier. Toll switches normally do not provide local telephone services.

In the current state of the art there are two inter-related messaging systems utilized within the PSTN. These are: (i) SS7; and (ii) ISDN (Integrated Services Digital Network), which incorporates a messaging system as an element of a broader product and service architecture. The SS7 messaging system extends through the major elements and systems of the PSTN, connecting virtually all of the local and long distance central offices, and carries call management (or call control) messages relating to call setup and disconnection and similar call management functions. Whereas the SS7 messaging system is oriented toward providing messaging communications among and between the PSTN switching systems, the ISDN messaging system is oriented toward extending the PSTN messaging system to the end devices such as telephones and office telephone systems. Rather than going off hook and drawing dial tone from the local central office switching system to initiate a call, as analog phones do, an ISDN phone sends a packetized digital call setup message to the switching system to initiate a call. Both the ISDN messaging system and the SS7 messaging system are based on the X.25/X.75 communications protocols. ISDN messages are carried on the SS7 messaging network. Disadvantageously, neither the SS7 nor the ISDN messaging systems carry any messages related to creating an Internet communication by one device dialing the telephone number of another.

The ISDN and SS7 messaging systems are call setup and call management (or call control) systems which carry a spectrum of messages, message responses, message acknowledgements, and the like, such as are necessary to conduct telecommunications. A full listing of all the message types that might be employed in a robust telecommunications environment has not been attempted herein, since that depth of information is not necessary to convey the essential elements of this invention. A brief listing of those message types include: (i) call setup request messages which convey dialing and associated information; (ii) busy signal messages telling the calling device to deliver a busy signal to the user; (iii) audible ring back messages telling the calling device to deliver “pacifier” ringing to the user; (iv) call request acceptance or rejection messages (v) call connect messages; (vi) call disconnect messages; (vii) switchhook flash messages; (viii) call transfer request messages; (ix) call conference messages; (x) call waiting messages; (xi) Caller-ID and Call Waiting-ID messages; and (xii) call forwarding messages to redirect a call to another device. In addition to these messages, a variety of other messages would be employed to indicate information like “network busy”, “invalid telephone number dialed”, and the like.

Conventional communication vehicles comprise computers and telephones. Computers typically have telephone lines attached to them, and telephones oftentimes have computers attached to them; but there is no true integration that enables the blending of the Internet and the PSTN. The level of integration that is presently attained permits a computer to use a phone line to dial into the Internet. Once on the Internet, the computer can access another computer by entering its Internet Protocol (IP) address into application software such as a browser.

In an associated matter, there are now a variety of technologies that provide both Internet and PSTN connectivity. These technologies include: (i) Voice over IP (ii) DSL service; (iii) cable modem service delivered by cable-TV systems; (iv) fixed wireless systems; and (v) Internet capable cellular wireless systems. The full benefits of integrated communications cannot be attained in current Internet and telecommunications environments. This patent application will address the environments of Voice over IP service, DSL service, and telephony service provided by cable-TV systems as illustrative of current environments. This application will describe enhancements to each of these arrangements as improvements over the state of the art, which will enable the desired Integrated Internet and PSTN communications. The following will describe the current state of the art for each of the specified illustrative environments.

In one aspect, the systems described herein relate to Voice over IP service. The term IP refers to the “Internet Protocol”, the basic protocol of the Internet, and the term Voice over IP refers to sending digitized voice across the Internet using the IP protocol. Several companies provide discount rate phone calls using “Voice over IP” (VoIP) technology, in which a long distance call of a client, typically a Personal Computer (PC) user, is carried over the Internet to a VoIP interface device in the vicinity of the called party. Such VoIP technology avoids the charges associated with placing a long distance call with a traditional long distance carrier. The VoIP interface device dials a local call on the PSTN to complete the connection for the VoIP client. Hence, the call travels partially over the Internet and partially over the PSTN as an analog call. A VoIP software application at the client device digitizes the user's voice and sends that as data messages across the Internet to the VoIP interface device. The VoIP interface device in turn converts the data messages to analog signals that are output onto the analog phone line. In the reverse direction, the VoIP interface device receives analog signals from the dialed phone and converts those analog signals to digital messages, which it sends across the Internet to the VoIP client. The VoIP software at the client converts those digital messages to analog signals, which are output to the user via speakers.

Referring to FIG. 1 of the drawings, Personal Computers (PCs) or similar devices 20 reside on a Local Area Network (LAN) 26 connected to the Internet 10 via an access line 24, commonly a T-1 type of circuit. Telephones 18 are connected to the telephone company (telco) switching system 14 by telephone lines 16. Switching system 14 resides in a telephone company facility called a Central Office (C.O.) 12, which also houses a Voice over IP (VoIP) interface device 22 having a similar access line 24 and multiple telephone lines 16. Although the VoIP interface device, and other interface devices discussed herein typically are co-located in the telco central office, it could be located elsewhere with the appropriate interconnecting circuits trunked in via any of a number of types of multiplexed data circuits. The purpose of this interface device is to allow Internet users to make voice telephone calls. Operationally, multiple, concurrent voice sessions are carried digitally over access connection 24 (multiplexed), and are demultiplexed or distributed to individual telephone lines 16 by the interface device 22.

The Voice over IP carrier provides each of its users with a software application (not shown) that enables the computer user to enter a number to be dialed. One of the computer users 20 dials a phone number by using the VoIP software application. That software application, perhaps operating in conjunction with other systems of the VoIP carrier, creates a logical connection to a remote VoIP interface device such as 22. Upon receiving a request from a user to create a telephone connection, the VoIP interface device 22 takes a local phone line 16 off hook and dials the number input by the user, such as that of a phone 18. When the remote party answers, a voice connection (or more correctly, a “voice grade” connection) is established. No means are provided for the calling and called device to create an Internet communication between themselves when one of the devices is called by dialing a telephone number.

In another aspect, the systems described herein relate to an Internet access technology currently being deployed that is referred to as DSL (Digital Subscriber Line) service. (The original acronym was ADSL, for Asynchronous Digital Subscriber Line.) Although there are some variations on the technology (now generically referred to as “xDSL”), it essentially involves an analog telephone line supplemented by a high frequency carrier signal superimposed on the telephone line by a pair of modems—one at the subscriber location, and one at the telephone company central office. The DSL carrier signal can carry high-speed data concurrently over the same phone line without interfering with the analog phone service. Other than being carried by the same physical wires, the phone line has no relationship to the DSL Internet service.

Referring to FIG. 2 of the drawings, the Internet is shown as 10, the telephone central office as 12 containing the telephone switching system 14 and a DSL interface device 28 incorporating DSL modem circuit cards 30. Analog telephone lines 16 connect from the telephone switching system 14 to the DSL modems 30. The DSL interface device has an access line 24 to the Internet. Emanating from the DSL interface device 28 are telephone lines 32 carrying the composite signal of analog plus carrier wave to the client devices. The carrier wave portion of the telephone lines 32 terminates in DSL subscriber modems 36, which split off the analog phone line 16 terminating on a phone 18 separately from a high speed data connection 34 to the user computer 20. The high-speed data connection 34 is typically an Ethernet connection. Thus, DSL service as currently provisioned provides an Ethernet connection to the user computer and an analog voice connection to the user phone. No means are provided for a calling and called device to create an Internet communication between themselves when one of the devices is called by dialing a telephone number.

In another instance, the matter to be discussed relates to virtual phone service provided via cable-TV. Cable-TV service has been used to provide high-speed Internet access—the popular “cable modem” service. In addition, there are a number of current activities related to delivering alternative provider telephone service via the cable-TV distribution system. Similar to the Internet access service arrangement, the telephony service arrangement utilizes a “cable modem” to transmit and receive voice grade telephone calls. Other than being carried by the same physical cable, telephone service provided by cable-TV has no relationship to the cable modem Internet service.

In FIG. 3 of the drawings, there is shown a telephone central office 12 encompassing a telephone switching system 14 and a cable telephony interface device 40 that provides telephony services to its client devices. Interface device 40 is connected to the switching system by telephone lines 16 (or multiplexed versions of these telephone lines). The interface device 40 is also connected by a multiplexed communications link 42 to a cable distribution hub 44 which has an access line 24 to the Internet and receives audio/video TV feeds via satellite 46 or similar feeder arrangement. The cable distribution hub 44 distributes Internet, telephony, and TV data via the cable 48. Tapped off the cable 48 are cable modems 50 which deliver a high speed Internet data link 34 (typically in Ethernet format) to PCs 19, 20, and 21, and which deliver telephone service to telephones 18. No means are provided for a calling and called device to create an Internet communication between themselves when one of the devices is called by dialing a telephone number.

A related matter is that of virtual phone service provided by the so-called fixed wireless arrangement, currently undergoing field trials in some areas, and by the newly introduced cellular telephone service with Internet access. Although these are substantially different services from a user perspective, the wireless infrastructure is much the same, so both arrangements will be presented in the same illustration.

Referring now to FIG. 4, there is the Internet 10, the telco central office 12 housing the telco switching system 14, which provides telephone lines 16 to local telephones 18, and to a voice interface device 60. The telephone lines 16 connecting to the voice interface 60 are shown as individual circuits, but typically would be delivered on high speed multiplexed trunk lines. Wireless arrangements often have the characteristic of being a subsidiary central office, and so we also show an SS7 messaging link 54 providing call management messaging services in cooperation with the rest of the PSTN. Voice interface device 60, even if acting as a central office, serves the same purposes as the interface devices discussed previously. In this instance it is shown remote from the telco central office and as a subsystem of the wireless provider's complex.

Components of that complex are herein discussed from a logical perspective, with the understanding that every manufacturer could label their devices in any fashion, and could incorporate various elements into combined units as suits their design concept. The complex includes a router 64 with access line 24 to the Internet, forming the Internet connectivity ultimately to be delivered to user devices. Router 64 connects to an encoder unit 62, part of the so-called “air interface”, which has responsibility of taking voice traffic from the voice interface 60 and router 64 traffic, and merging them into a single stream for delivery to the transmitter and antenna 68. Broadcast arrangements such as this take advantage of multiple radio frequencies, a variety of static and dynamic frequency assignment techniques, and varieties of addressing and data packetization for transmission over the air—much of these arrangements being proprietary to particular manufacturers. The encoder unit dynamically assigns the proper frequency, addressing, and packetization to the voice and data information to be transmitted to each receiver, and does the reverse to decode and direct received data to the router and voice switch interface device. Management unit 66 provides overall control and coordination of the complex, keeping track of static and dynamic assignments used for individual client devices in records system 78.

For the fixed wireless arrangement, a receiver complex is associated with each subscriber or subscriber group, consisting of a dish antenna 70, a decoder/modem device 72 which does functions similar to that of encoder 62, and which delivers the individual voice and data streams to and from its connected telephones 18 and PCs 20. The PC 20 is connected by an Ethernet link 34 to modem 72. Wireless handsets 76 incorporate similar functions in a composite fashion, having an antenna, decoder/modem logic, and a dual purpose display screen and audio system to function for both Internet applications and voice telephony applications.

In operation, if a user computer 20 or wireless handset 76 initiates an Internet session, the associated data traffic is encoded and decoded at the modem-type device 72 or the equivalent logical component integral to handset 76, and transmitted over the air to the wireless complex, where encoder 62 decodes and directs the traffic to the router 64, which delivers it to and from the Internet. If a user phone 18 or wireless handset 76 dials a call, a data message is created and sent over the same path, but is directed by encoder 62 to the voice interface 60, which associates the voice data stream with a telephone line 16 and places the phone call.

It is important to understand that in this configuration, there in fact is a messaging capability extended to the subscriber's premises in fixed wireless, or to the cellular handset. One messaging capability being from the Internet router 64 to PC 20, or to the control logic of the handset 76, and another being from voice interface 60 to modem 72, or to the control logic of the handset 76. The connection from modem 72 to phone 18 is shown as simple analog phone line, with no messaging capability, although there is no reason why a provider of fixed wireless service could not supply ISDN connectivity so the subscriber could use an ISDN phone. If that were the case, then clearly a messaging capability would extend to all devices in the arrangement.

The deficiency of this arrangement then is that, even though it has suitable physical arrangements, it is not provisioned with appropriate software to perform the necessary functions and to supply the types of messages necessary to implement the Internet to telephony integration functions described in this patent application. Explicitly, no means are provided for a calling and called device to create an Internet communication between themselves when one of the devices is called by dialing a telephone number. It is also particularly important to understand that any such capability must extend beyond the sphere of service offered by a particular provider to the PSTN and Internet as a whole, such that a subscriber of these wireless services could create an Internet connection with any appropriately configured device simply by dialing its telephone number, and such that an appropriately configured telephony device could create an Internet connection with any wireless subscriber device simply by dialing its telephone number.

From the specific arrangements discussed herein, it should be obvious that any similar arrangements involving a telco central office interface device which provides Internet and telephony services for client devices would be subject to the inventive matter in this patent application. By generic extension, that includes systems which might be considered central offices themselves. So, even though this document may not have discussed every possible arrangement of central office interface devices, all arrangements are intended to be covered by the scope of this application.

In view of the foregoing description of the current state of the art, it is apparent that the conventional systems presently in use do not suggest or demonstrate how a device in one of these current environments can create an Internet connection with the called device by dialing its telephone number. Because of this void, there remains a need in the art for a method and means to provide Integrated communications in environments of this type.

### SUMMARY OF THE INVENTION

There is a class of devices, such as those for Voice over IP, DSL, cable TV, ISDN, fixed wireless, Internet capable wireless cellular, and similar distribution systems, which provide Internet and telephony services to their client devices, such as phones and PCs, by providing an interface to the telephone company central office switching system. The present invention provides a method and means for facilitating the integration of the Internet with the Public Switched Telephone Network (PSTN) by providing such Internet and telephony interface devices with a messaging communications link to a telephone central office switching system (or to an appropriate related system acting as the agent of the switching system). The communications link carries call setup, telephone number, and IP address messages to and from the switching system, the interface device, and to and from the client terminal devices of the interface device, as described in greater detail hereinafter. The capabilities afforded by the enhancements to these interface devices, as specified by this document, enable Internet communications to be established by one device calling the telephone number of another wherein either or both of the calling and called devices are clients of an interface device.

The PSTN utilizes a messaging system called SS7 to carry call related messages between telephone switching systems; in addition, the telecommunications technology ISDN provides a messaging capability for carrying similar messages between telephone systems and devices. The messaging communications link might therefore use one of these existing technologies. Optionally, the Internet might be utilized as the messaging communications system. The messaging communications extends directly or indirectly to one or the other or both of the calling and called devices. The purpose of the messaging is to provide the calling or called device, or both, adequate information to conduct a communication between themselves over the Internet when that communication was started by one device calling the telephone number of the other device.

As specified in the co-pending patent applications discussed hereinafter, devices for integrating the Internet with the PSTN (“Integrated Devices”) have both an Internet connection with an associated IP address, and have a telephone connection with an associated telephone number. The telephone connection to the PSTN could be a virtual telephone line, such as that being provided over cable-TV systems. Additionally, Integrated Devices provide a messaging communications capability for communicating call setup and call control messages with the PSTN wherein the messages convey telephone number and IP address information.

According to the co-pending patent applications, the general process of integrating the Internet with the PSTN is to obtain the IP address of either the calling or called device and deliver it to the other device. Cross-references are provided for which relate IP addresses to telephone numbers. The cross-references can be maintained in the terminal devices themselves, in the Internet such as in an enhanced Domain Name Service (DNS) system, or in the PSTN. In the latter case, the cross-reference could be provided by the telco central office switching system or associated elements, or by the interface devices that are the subject of this patent application. An IP address is obtained from a cross-reference. Once the IP address is obtained for either or both of the calling and called devices, it is delivered to the other device via a messaging system as previously mentioned.

Among a wide variety of possibilities, there are three primary scenarios involved in the establishment of an Integrated Internet/PSTN call. In the first scenario, the interface device will receive a call setup request digital message from the calling device, and will relay that request to the telco switching system by sending an appropriate message to it. That message would contain the called telephone number (TN), and perhaps other information to facilitate the process, such as a message number or the IP address and TN of the caller. On receiving the call setup request from the interface device, the telco switching system will attempt to determine if the called TN is an Integrated Device, as defined in the co-pending patent application.

If the called TN is an Integrated Device (or system, or service, or the like), the Telco switching system will determine the IP address associated with the called TN via one of multiple available means, as defined in the co-pending patent application. As for example, the telco switching system may have available to it a record of that information, perhaps from a service or installation activity. Upon determining the IP address of the called TN, the switching system will transmit that information in a reply message to the interface device. The interface device will then send that information back to the calling device in a digital message. The calling device, now having the IP address of the called TN, can establish an Internet communication with the desired device via its IP address. In the process, either the calling or called devices may elect to conduct any part of the communication via the Internet, and may elect to continue or abandon the voice call over the PSTN. Variations of this scheme allow for the serving telco switching system of either or both of the calling or called device to provide the IP address of the client device, and to deliver that IP address to the other switching system, and then to the device served by that other switching system.

In another variation of this scenario, the interface device maintains a cross-reference of IP addresses for its client devices. In this variation, the interface device could add the IP address to the call setup message stream for either of the calling and called devices, and forward the message to the interface device's serving central office switching system. The switching system would then forward that message (or an equivalent) to the remote serving central office as before.

In a second scenario, if the call setup message includes the calling device's IP address, the telco switching system may forward it (or its essential elements) to the called device (remembering the global SS7 network, the called device can be near or far). Considering for ease of discussion that the called device is served out of the same telco central office, the switching system can forward it to its associated interface device, which will forward it to the called device. The called device, now having the IP address of the calling device, can establish an Internet communication with the calling device via its IP address. A variation of this scenario provides the ability for the devices to exchange IP addresses between themselves across the PSTN messaging system. In this scenario the PSTN facilitates such a message communications by creating a messaging pathway between the calling and called devices, such as occurs in the call setup process of ISDN.

In a third scenario, the call setup request may not come in the form of a digital message, but in the form of dialed digits on an analog phone line received directly by the telco switching system. In this scenario, the telco central office switching system will determine if both the calling and called devices are Integrated Devices via investigating its service records for those devices. If they are Integrated Devices, the switching system will obtain the calling device's IP address from the service record, and will create a call setup message containing the calling TN and IP address. The switching system will send this call setup message to the interface device providing services for the called device; the interface device will then forward the call setup message (or its essential elements) to the called device. The called device, now having the IP address of the calling device, can establish an Internet communication with the calling device via its IP address. As in the previous scenarios, the arrangement could be reversed, with the PSTN obtaining the IP address of the calling device, and delivering that IP address information to the called device via similar processes.

Accordingly, the present invention provides a method and means for creating an Internet communication with a calling device when the called TN is an Integrated Device, the arrangement being such that either the calling or the called device is provided Internet or telephony service by an interface device.

### BRIEF DESCRIPTION OF THE DRAWINGS

The invention will be more fully understood when reference is had to the following detailed description of the preferred embodiment of the invention and the accompanying drawings, in which:

FIG. 1 is a schematic diagram depicting PCs on the Internet, that are able to communicate with telephones using Voice over IP technology in the current state of the art;

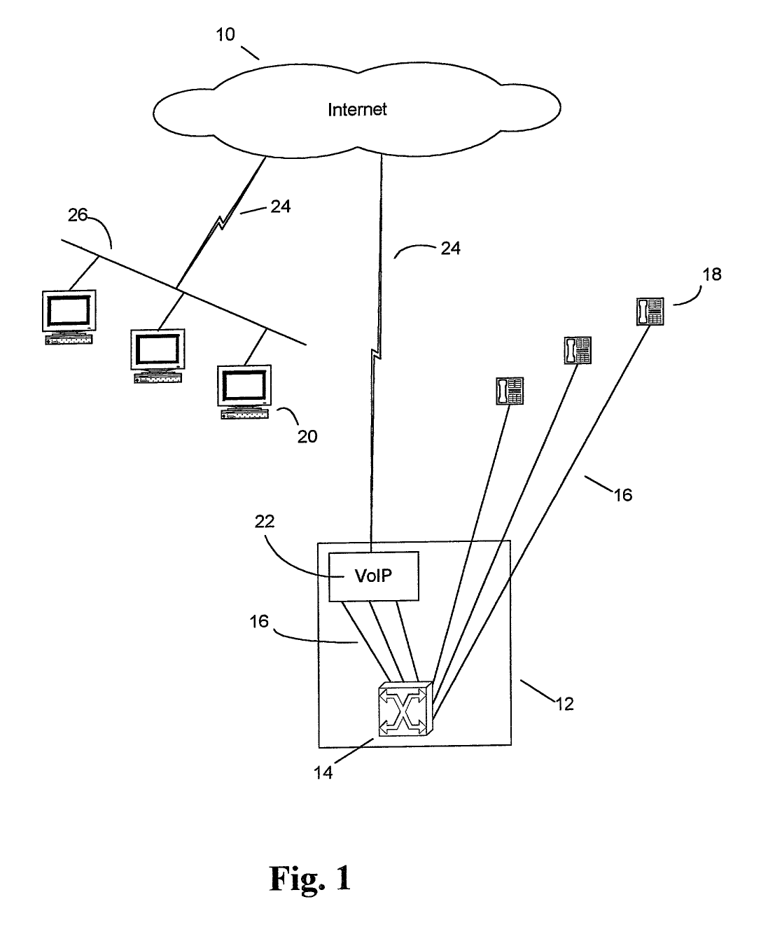

FIG. 2 is a schematic diagram illustrating a DSL arrangement in the current state of the art;

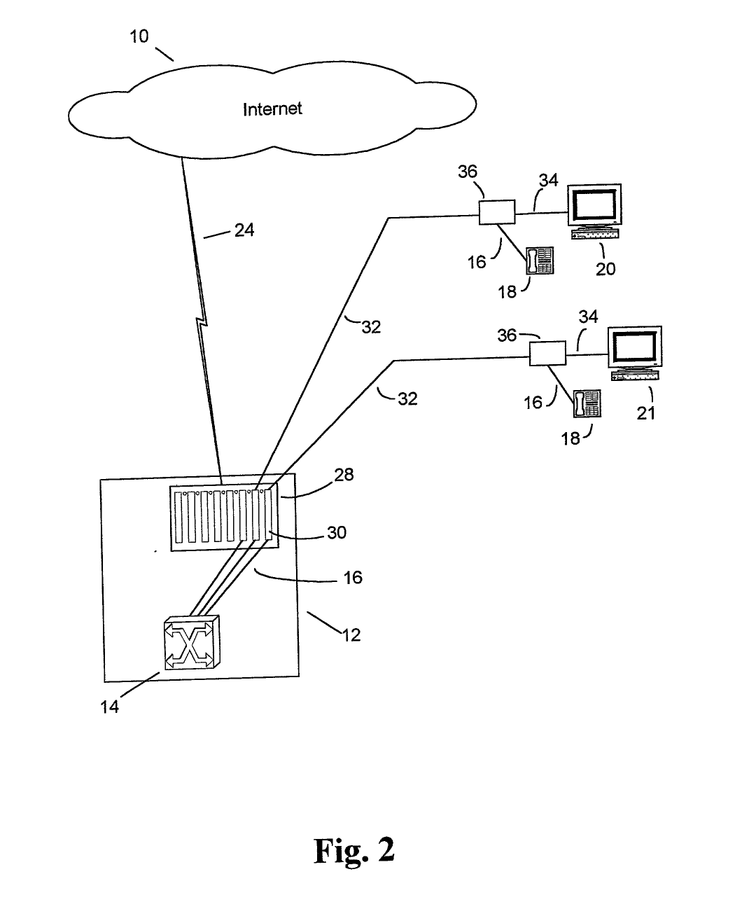

FIG. 3 illustrates diagrammatically a cable-TV distribution arrangement providing cable modem Internet access and telephony service in the current state of the art;

FIG. 4 is a diagrammatic illustration of wireless Internet and telephony service arrangements in the current state of the art;

FIG. 5 is a schematic diagram of the preferred embodiment in a VoIP environment in which the VoIP interface device has a messaging communication link to its respective telco switching system and to its terminal devices;

FIG. 6 is a schematic diagram of another version of the preferred embodiment in a DSL environment in which the DSL interface device has a messaging communication link to its respective telco switching system and to its terminal devices;

FIG. 7 illustrates schematically another version of the preferred embodiment in a cable-TV environment in which the cable-TV interface device has a messaging communications link to its respective telco switching system and to its terminal devices;

FIG. 8 is a schematic diagram illustrating another version of the preferred embodiment in a wireless environment in which the wireless service provider interface device or system has a messaging communications link to its respective telco switching system and to its terminal devices; and

FIG. 9 is a schematic diagram illustrating implementation of an ISDN PBX and an ISDN telephone, the ISDN PBX being representative of messaging based office telephone systems.

### DETAILED DESCRIPTION OF THE INVENTION

Central to the principles and practice of this invention, as well as the inventions described by the co-pending patent applications, is the presence of means for enabling a calling device to create an Internet communication with another device simply by dialing its telephone number, thus integrating the Internet with the PSTN. The co-pending patent applications describe various aspects of this integration. One benefit of such integration is that traditional voice-only telephone calls can be augmented or replaced with multimedia communications using Internet protocols and capabilities. Such multimedia communications may include: voice and other audio; graphics, images and other visual material; motion video; and synchronized audio and video transmitted together including TV video and videophone service. The data for these multimedia communications may be transmitted on the Internet as a result of the integration described herein. The enhanced capabilities provided by the present invention facilitate that integration.

The following provides an overview of the co-pending patent applications.

Co-pending patent application entitled “Integrated Device For Integrating The Internet With The Public Switched Telephone Network”, Serial No. 60/301,756, Docket No. 0054-3, describes “Integrated Devices” for integrating the Internet with the PSTN, which have an Internet connection with an associated IP address, a PSTN connection with an associated telephone number, and a digital messaging connection to the PSTN for conveying call management messages to include messages containing telephone numbers and IP addresses.

Co-pending application entitled “Integrating the Internet with the Public Switched Telephone Network”, Serial No. 60/301,757, Attorney Docket No. 0054-4, discloses an enhanced communications environment in which a telephone call placed to an Integrated Device can create end-to-end communications over the Internet rather than partially or exclusively over the PSTN.

Co-pending patent application entitled “Telephone Switching System For Integrating The Internet With The Public Switched Telephone Network”, Serial No. 60/306,294, Attorney Docket No. 0054-7, discloses a method and means for a telephone central office switching system to enable a calling device to establish an Internet communication with a called device by dialing its telephone number.

Co-pending patent application entitled “Integrated Telephone Central Office Systems For Integrating The Internet With The Public Switched Telephone Network”, Serial No. 60/306,293, Attorney Docket No. 0054-8, discloses an integrated assembly of telephone central office switching system integrated interface devices, comprising telephone central office switching systems, and switching system interface devices such as those for providing DSL service, Voice over IP (VoIP) service, cable modem service, fixed wireless service, and Internet capable cellular wireless service. The integrated telephone central office systems therein described offers efficiencies and economies further benefiting the integration of the Internet with the PSTN.

A messaging system such as that specified in the co-pending patent application entitled “Call Management Messaging System For Integrating The Internet With The Public Switched Telephone Network”, Serial No. 60/311,401, Attorney Docket No. 0054-9, exchanges call management messages such as call setup requests, call disconnect messages, Call Forwarding messages, and so on, between communications systems and user devices, either being connected to the Internet, the PSTN, or to both.

Co-pending patent application entitled “Interactive Device Control System For Integrating The Internet With The Public Switched Telephone Network”, Serial No. 60/317,055, Attorney Docket No. 0054-11, discloses a system for the PSTN and the Internet in which a communications system offers the user of a device such as a screen phone the ability to control or influence functions of the communications system by presenting the user with a displayed menu of options. The menu of options is sent to the user's device by the communications system via a messaging system. Selection of an option by the user returns a response message to the communications system via the messaging system. Upon receipt of the response message, the communications system actuates the function associated with the user-selected option. The interactive device control system operates seamlessly across both the Internet and the PSTN, thus providing further integration of those two networks.

Co-pending patent application entitled “Stored Profile System For Storing And Exchanging User And System Communications Profiles To Integrate The Internet With The Public Switched Telephone Network”, Serial No. 60/317,057, Attorney Docket No. 0054-12, discloses a system for the PSTN and the Internet to maintain and exchange communications related information such as hardware capabilities and personal information and preferences. The Stored Profile System enables devices to synchronize and optimize their communications capabilities, and enables users to exchange contact information such as Electronic Business Cards as a part of call setup, operating like an enhanced Caller-ID. The stored profiles capability extends to communications systems on both the PSTN and the Internet, thus further promoting the integration of the Internet with the PSTN.

Central to the principles and practice of this invention, as well as the inventions described by the co-pending patent applications, is the presence of means for enabling a calling device to create an Internet communication with another device simply by dialing its telephone number, thus integrating the Internet with the PSTN. The co-pending applications describe an environment in which the various elements of the PSTN are enabled to conduct digital, packetized messages, which communicate essential information between various devices across the Internet and the PSTN to provide for this integration. Although not limited to the scope of the following listing, these enabled PSTN elements include: (i) the end or terminal devices such as telephones and Integrated Devices; (ii) telephone central switching system interface devices, such as those for VoIP, DSL, cable-TV, fixed wireless and Internet enabled cellular wireless, and the like, which provide telephony and Internet services for client devices; (iii) telephone central office switching systems which provide telephony services for client devices; (iv) telephone long distance switching systems which provide long distance capabilities on the PSTN; (v) office telephone systems such as PBXs, Key Systems and the like; and, (vi) adjunct devices such as automated attendant systems, automatic call distributors, voice mail systems, and the like.

Some of these devices, including the end or terminal devices, are uniquely addressable within the messaging system via an IP address, telephone number, or other identifier associated with the device. Other identifiers could include an internal system reference (e.g., module, cabinet, shelf, slot, port number), an ISDN (Integrated Services Digital Network) address, or the like. Regardless of the nature of the address, Integrated Devices have messaging addresses known to the serving system such as a telephone central office switching system, telephone central office switching system interface device, office telephone system, and the like, such that the serving system can communicate with the Integrated Devices via the messaging system.

The messaging system common to this invention and the inventions of the co-pending patent applications connects between each of these devices and systems, and the messages of which the messaging system is comprised are transmitted to and between each of these devices as are necessary for any individual communication. Some devices and systems may simply act as a pass-through for the message stream by passively or actively forwarding messages, or may act as a pass-through for specific message types while acting upon others. Each device or system may send, receive, forward, or act upon any given message as is necessary to accomplish the message functions. Messages may be sent in one or more pieces from one device to the next, and devices may assemble, reformat, re-packetize, augment a message with additional data, or otherwise manipulate a message as is processed through the system.

The co-pending applications described hereinabove provide reference information useful in developing a full understanding of the present invention as it relates to these systems and devices. Accordingly, the disclosure of each aforementioned co-pending application is incorporated herein by specific reference thereto.

Certain enhancements over the co-pending patent applications are herein described.

The co-pending applications discussed above describe an enhanced communications environment in which a telephone call placed to an Integrated Device creates an end-to-end communications over the Internet rather than over the PSTN. The inventions of the co-pending patent applications provide for a method and means to obtain the IP address of at least one of the calling and called devices and to provide that IP address to the other, such that one of the two devices can initiate an Internet communication with the other. There is a class of devices, such as those for Voice over IP, DSL, cable TV, ISDN, fixed wireless, Internet capable wireless cellular, and similar distribution systems, which provide Internet and telephony services to their client devices, such as phones and PCs, by providing an interface to the telephone company central office switching system. The instant invention is related to the co-pending application, but augments the system therein disclosed by providing a means for the telephone central office switching system to engage in specific messaging communications with telephony and Internet interface devices. Such messaging facilitates the end-to-end Internet communications as desired.

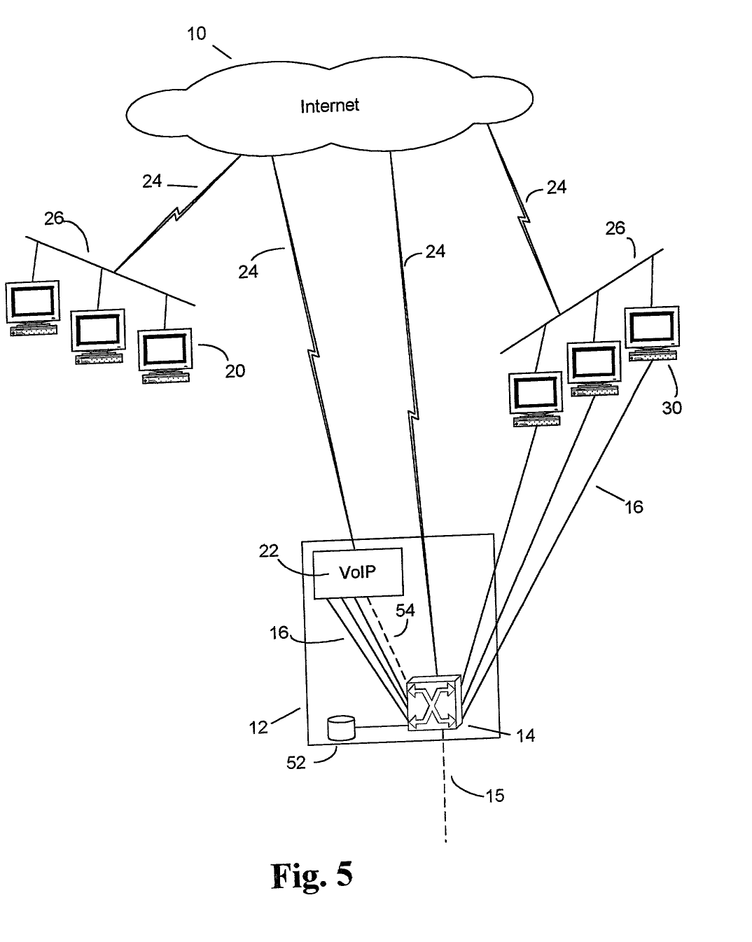

FIG. 5 depicts the preferred embodiment of this invention in a VoIP environment. Referring to FIG. 5, Personal Computers (PCs) or similar devices 20 reside on a Local Area Network (LAN) 26 connected to the Internet 10 via an access line 24, commonly a T-1 type of circuit. Integrated Device workstations 30 are connected to the telephone company (telco) switching system 14 by telephone lines 16 and reside on another LAN 26 having an access line 24 to the Internet. Switching system 14 optionally has an access line 24 providing Internet connectivity for the switching system which allows the switching system to send Internet messages to its client devices. Switching system 14 resides in a telephone company Central Office (C.O.) facility 12, which also houses a Voice over IP (VoIP) interface device 22 having a similar access line 24 and multiple telephone lines 16. The VoIP interface device also has a messaging communications link 54 to the telco switching system 14 for communicating messages relevant to creating Internet communications. As stated previously, a commercially manufactured VoIP interface device may incorporate an SS7 or ISDN messaging channel to the telco switch for other purposes, and this channel or other suitable channel may be applied to satisfy the requirements of this patent application for carrying call setup, telephone number and IP address messages between the telco switching system 14 and the interface device 22. Optionally, the VoIP interface device 22 and switching system 14 could transact the necessary messages using the Internet as the supporting messaging channel, each sending messages to the other via Internet access links 24.

The Voice over IP carrier provides each of its users with a software application (not shown) that enables the computer user to enter a number to be dialed. One of the computer users 20 dials the telephone number of an Integrated Device workstation 30 by using the VoIP software application. That software application, perhaps operating in conjunction with other systems of the VoIP carrier, creates a logical connection to a remote VoIP interface device such as 22 by sending a call setup request message to it over the Internet. The call setup request message contains the called TN as well as the calling device's IP address. Upon receiving a request message from a user to create a telephone connection, the VoIP interface device 22 forwards a similar and perhaps identical message via communications link 54 to telephone switching system 14 containing call setup message elements such as the called TN and calling device's IP address, plus any other relevant information necessary to facilitate the messaging communication. Telephone switching system 14 searches a records system 52 to determine if the called TN has an IP address associated with it. If it does, the switching system 14 returns the called device's IP address in a response message to the VoIP interface device 22 via messaging communications link 54. Upon receiving the called telephone number's associated IP address, VoIP interface device 22 sends an Internet message to the calling device 20 providing the IP address of the called TN. Said Internet message may simply be a forwarded copy of the response message from the switching system 14. The calling device 20 may then communicate directly with the called device via the Internet by directing communications to it via its IP address. The telephone switching system 14 has SS7 messaging communications links 15 to other telephone switching systems around the world, enabling, for example, a remote telephone switching system to look up a service record if necessary.

In an alternative mode of operation the called device is responsible for creating the final Internet communications with the calling device—something like answering the call via the Internet. As before, an Internet user or the user's device 20 “dials” a VoIP call to a TN of a user device 30 by entering the called TN into the VoIP application software. The application software sends a call setup request message including the called TN and calling device's IP address to a VoIP interface device 22 in the locale of the called TN. The interface device 22 receives the call setup request message and relays the message or forwards essential elements of the call setup message to the telco switching system 14, the relayed message including the called TN and the caller's IP address, said message being routed over the messaging communications link 54. The telco switching system 14 or an associated system determines the IP address for the called TN. The telco switch sends a return message to the interface device 22, the return message including the IP address of the called TN, the called TN, and the IP address of the calling device 20, said return message also being routed over the messaging communications link 54. The interface device 22 relays the message from the switch 14 to the IP address of the called device 30 via the Internet, said message including the IP address of the calling device 20. And, the called device 30, now having the IP address of the calling device 20, establishes a direct communication with the calling device over the Internet via its IP address.

Optionally, switching system 14 may communicate a message containing the calling device's IP address to the called device 30 by sending an Internet message to the called device, the message being transported to the Internet via access line 24 which provides Internet connectivity to switching system 14.

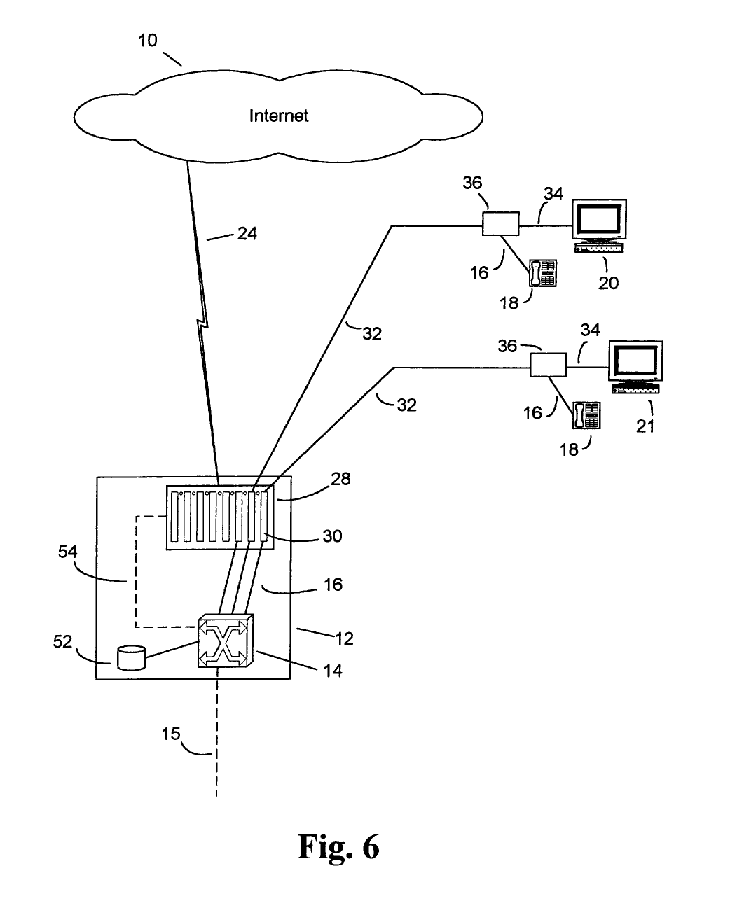

FIG. 6 illustrates the preferred embodiment in a DSL environment. Referring to FIG. 6, telephone central office 12 encompasses telephone switching system 14 having telephone lines 16 to DSL interface device 28 incorporating DSL modem circuit cards 30. The DSL interface device 28 has an access line 24 to the Internet. Emanating from the DSL interface device 28 are telephone lines 32 carrying the composite signal of analog plus carrier wave. The carrier wave portion of the telephone lines 32 terminates in DSL subscriber modems 36, which split off the analog phone line 16 terminating on a phone 18 separately from a high speed data connection 34 to the user computers 20 and 21. The high-speed data connection 34 typically is an Ethernet connection. The carrier wave portion 32 and the high speed data connection 34 both carry call setup and call control messages, along with digitized voice and Internet data, between the interface device 28, and the user computer 20. As in other examples, user computer 20 is utilized as a communications device in lieu of a conventional telephone. The telephone switching system 14 has available to it information 52 such as from subscriber service records which include the telephone number and associated IP address of its Integrated Device subscribers. The telephone switching system 14 has SS7 messaging communications links 15 to other telephone switching systems around the world, enabling, for example, a remote telephone switching system to look up a service record if necessary.

Operationally, from the perspective of this invention, the DSL embodiment is similar to the VoIP operation previously described. In this example a computer such as 20 is used to place multimedia telephone calls, rather than the associated telephone 18. A computer user 20 “dials” a call to a TN such as that for computer 21. Application software in the computer device 20 sends a call setup message to the DSL interface device 28, said call setup message including the called TN and the IP address, and optionally the TN, for calling device 20. The interface device 28 receives the call setup request and relays it to the telco switching system 14 in a message containing the called TN and sufficient other identifying information for the routing of a return message, said message being routed over the messaging communications link 54. The telco switching system 14 or an associated system or agent determines the IP address for the called TN. The telco switch 14 sends the IP address to the interface device 28 in a return message, said return message optionally including the IP address and TN of the calling device 20, and said return message also being routed over the messaging communications link 54. The interface device 28 relays the IP address of the called device 21 to the calling device 20. The calling device 20, now having the IP address of the destination system 21 for which it originally had the TN, establishes a direct communication with the called device 21 over the Internet via its IP address. In the environment as shown, such an Internet communication may transpire entirely within the DSL arrangement since both subscribers are served by the same interface device.

In an alternative mode of operation of the DSL version, similar to the alternative mode of operation for the VoIP version, the called device is responsible for creating the final Internet communications with the calling device—something like answering the call via the Internet. As before, an Internet user or the user's device 20 “dials” a call to a TN of a user device 21 by entering the called TN into an application software. The application software sends a call setup request message including the called TN and calling device's IP address to interface device 28. The interface device 28 receives the call setup request message and relays the message or forwards essential elements of the call setup message to the telco switching system 14, the relayed message including the called TN and the caller's IP address, and optionally, the caller's TN and other routing information, said message being routed over the messaging communications link 54. Since the IP address of the calling device has already been identified to the switching system 14, it only needs to identify a messaging path or similar identifier of the called device 21 in order to send it the IP address of the calling device 20. The telco switching system 14 or an associated system determines if the called device is an Integrated Device subscriber, and optionally obtains the IP address for the called TN or other identifier for the called device. The telco switch 14 sends a return message to the interface device 28, the return message including the called TN, optionally the IP address of the called TN, optionally any identifier of the called device, and the IP address of the calling device 20, said return message also being routed over the messaging communications link 54. The interface device 28 relays the message from the switch 14 to the called device 21 via the messaging channel of the DSL connection 32, said message including the IP address of the calling device 20. Interface device 28 determines the physical circuit associated with said called device 21 via its IP address, telephone number, or other identifier provided by said switching system 14. The called device 21, now having the IP address of the calling device 20, establishes a direct communication with the calling device over the Internet via its IP address. In the environment as shown, such an Internet communication may transpire entirely within the DSL arrangement since both subscribers are served by the same interface device.

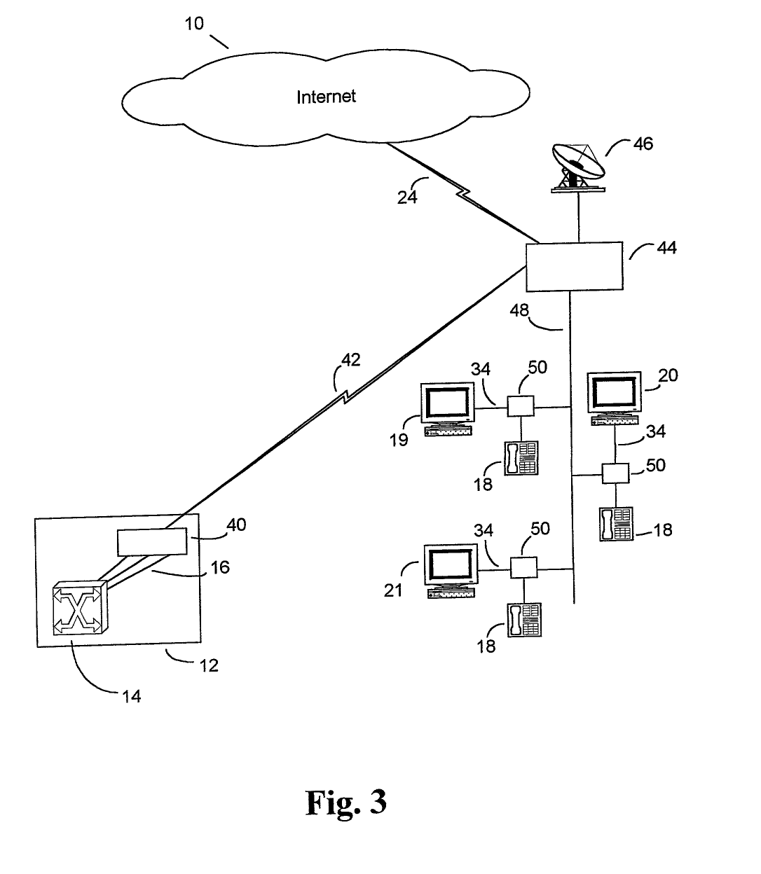

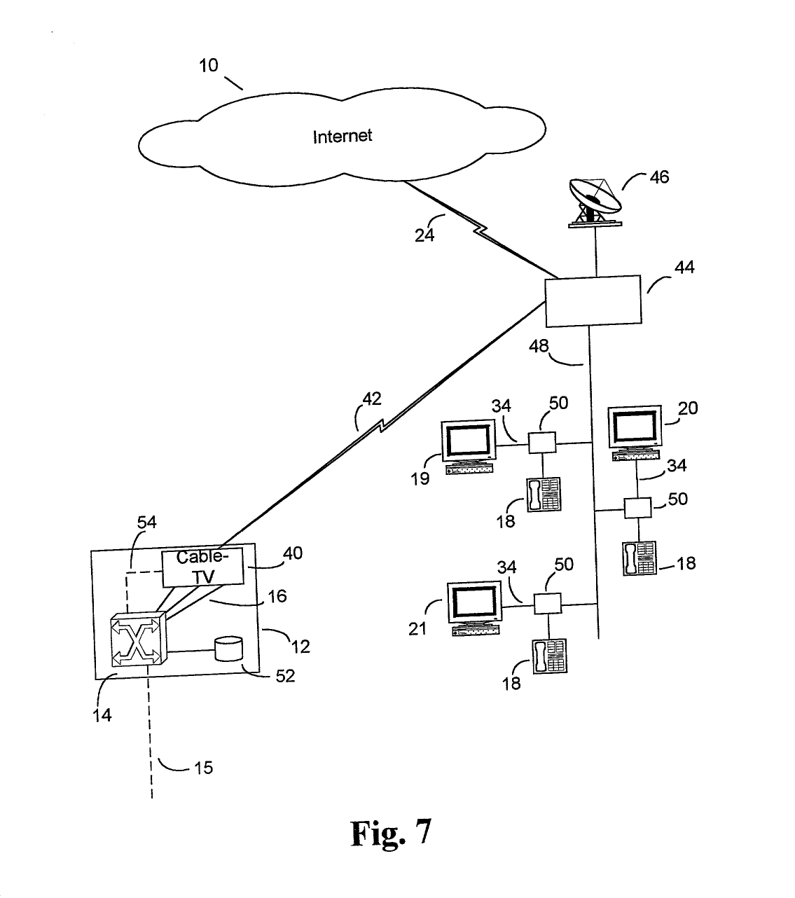

Referring now to FIG. 7 in describing a cable-TV arrangement, we see the same elements as FIG. 3, recited here for ease of reading. There is a telephone central office 12 encompassing a telephone switching system 14 and a cable telephony interface device 40 which is connected to the switching system by telephone lines 16 (or multiplexed versions of these telephone lines). The interface device 40 is connected by a multiplexed communications link 42 to a cable distribution hub 44 which has an access line 24 to the Internet and receives audio/video TV feeds via satellite 46 or similar feeder arrangement. The cable distribution hub 44 distributes Internet, telephony, and TV data via the cable 48. Tapped off the cable 48 are cable modems 50 which deliver a high speed Internet data link 34 (typically in Ethernet format) to PCs 19, 20, and 21, and which deliver telephone service to telephones 18. In addition, FIG. 7 now adds messaging communications link 54 from the telco switching system 14 to the cable-TV interface device 40, and service records 52 or other information which include the telephone number and associated IP addresses of its Integrated Device subscribers. Also, multiplexed communications link 42, cable 48, and Ethernet link 34 now also carry call setup and call control messages, along with digitized voice and Internet data, between the interface device 40 and user computers 19, 20, and 21. The telephone switching system 14 has SS7 messaging communications links 15 to other telephone switching systems around the world, enabling, for example, a remote telephone switching system to look up a service record if necessary.

Operationally, from the perspective of this invention, the cable-TV embodiment is similar to the DSL operation previously described. In this example a computer such as 20 is used to place multimedia telephone calls, rather than the associated telephone 18. A computer user 20 “dials” a call to a TN such as that for computer 21. Application software in the computer device 20 sends a call setup message to the cable-TV interface device 40, said call setup message including the called TN and the IP address, and optionally the TN, for calling device 20. The interface device 40 receives the call setup request and relays it to the telco switching system 14 in a message containing the called TN and sufficient other identifying information for the routing of a return message, said message being routed over the messaging communications link 54. The telco switching system 14 or an associated system or agent determines the IP address for the called TN. The telco switch 14 sends the IP address to the interface device 40 in a return message, said return message optionally including the IP address and TN of the calling device 20, and said return message also being routed over the messaging communications link 54. The interface device 40 relays the IP address of the called device 21 via a message to the calling device 20 via the multiplexed communications link 42, cable 48, and Ethernet link 34. The calling device 20, now having the IP address of the destination system 21 for which it originally had the TN, establishes a direct communication with the called device 21 over the Internet via its IP address. In the environment as shown, such an Internet communication may transpire entirely within the cable-TV arrangement since both subscribers are served by the same interface device.

In an alternative mode of operation of the cable-TV version, similar to the alternative mode of operation for the DSL version, the called device is responsible for creating the final Internet communications with the calling device—something like answering the call via the Internet. As before, an Internet user or the user's device 20 “dials” a call to a TN of a user device 21 by entering the called TN into an application software. The application software sends a call setup request message including the called TN and calling device's IP address to cable-TV interface device 40. The interface device 40 receives the call setup request message and relays the message or forwards essential elements of the call setup message to the telco switching system 14, the relayed message including the called TN and the caller's IP address, and optionally, the caller's TN and other routing information, said message being routed over the messaging communications link 54. Since the IP address of the calling device has already been identified to the switching system 14, it only needs to identify a messaging path or similar identifier of the called device 21 in order to send it the IP address of the calling device 20. The telco switching system 14 or an associated system determines if the called device is an Integrated Device, and optionally determines the IP address for the called TN. The telco switch 14 sends a return message to the interface device 40, the return message including the IP address of the called TN, the called TN, and the IP address of the calling device 20, said return message also being routed over the messaging communications link 54. Interface device 40 determines the appropriate addressing associated with said called device 21 via its IP address, telephone number, or other identifier provided by said switching system 14. The interface device 40 relays the message from the switch 14 to the called device 21 via the multiplexed communications link 42, cable 48, and Ethernet link 34, said message including the IP address of the calling device 20. The called device 21, now having the IP address of the calling device 20, establishes a direct communication with the calling device over the Internet via its IP address. In the environment as shown, such an Internet communication may transpire entirely within the cable-TV arrangement since both subscribers are served by the same interface device.

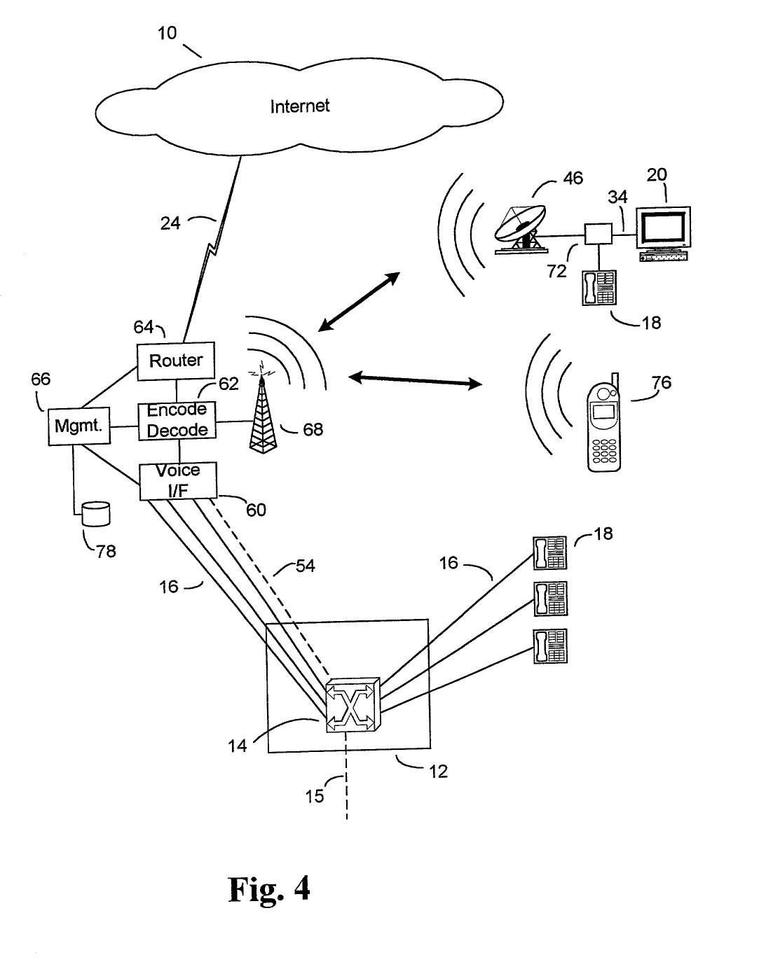

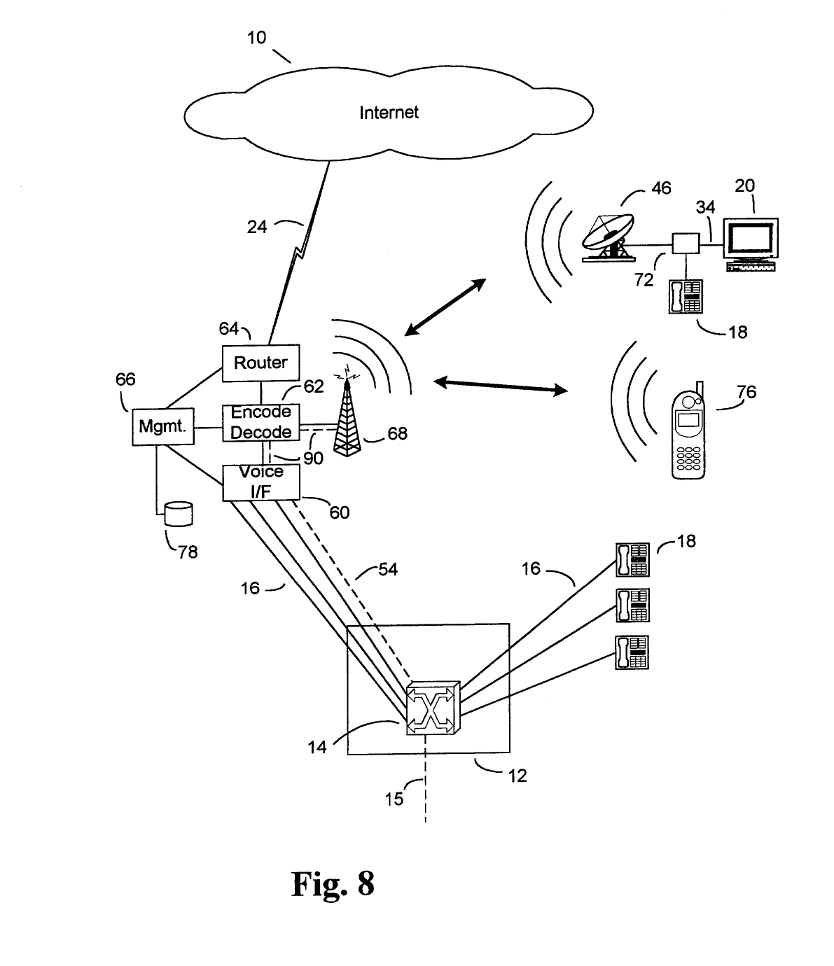

FIG. 8 illustrates the preferred embodiment in a wireless environment for both fixed wireless service and cellular handsets with Internet access. Referring now to FIG. 8, we see the same illustration as described in FIG. 4, with the addition of records system 52 as a component of the telco switching system 14, and we see the telco messaging communications link 54 extended to the encoder 62 and transmitter and antenna 68 via communications link 90. Although not shown, the messaging link extends across the wireless medium to the terminal devices of the modem 72, computer 20, and wireless handset 76.

Operationally, a handset user 76 “dials” a call to a TN such as that for computer 20. Application software in the handset 20 sends a call setup message to the wireless voice interface device 60, said call setup message including the called TN, and the IP address, and optionally the TN, for calling device 76. The interface device 60 receives the call setup request and relays it to the telco switching system 14 in a message containing the called TN and sufficient other identifying information for the routing of a return message, said message being routed over the messaging communications link 54. For purposes of this example, presume that the fixed wireless carrier providing service for computer 20 is a different carrier than the cellular wireless carrier providing service for handset 76, both carriers having a similar complex of equipment. The telco switching system 14 or an associated system or agent determines the IP address for the called TN. In one possible scenario, the management system 66, or the voice interface 60 might have that information available, and provide it to the telco switch 14 as part of the call setup message. The telco switch 14 sends the IP address to the interface device 60 in a return message, said return message optionally including the IP address and TN of the calling device 76, and said return message also being routed over the messaging communications link 54. The interface device 60 relays the IP address of the called device 20 in a message to the calling device 76 via the wireless communications link. The calling device 76, now having the IP address of the destination system 20 for which it originally had the TN, establishes a direct communication with the called device 20 over the Internet via its IP address.

In an alternative mode of operation of the wireless version the called device is responsible for creating the final Internet communications with the calling device—something like answering the call via the Internet. As before, a wireless user device 76 “dials” a call to a TN of a user device 20 by entering the called TN into an application software. The application software sends a call setup request message including the called TN and calling device's IP address to voice interface device 60. The interface device 60 receives the call setup request message and relays the message or forwards essential elements of the call setup message to the telco switching system 14, the relayed message including the called TN and the caller's IP address, and optionally, the caller's TN and other routing information, said message being routed over the messaging communications link 54. The telco switching system 14 or an associated system determines the IP address for the called TN. The telco switch 14 sends a return message to the interface device 60, the return message including the IP address of the called TN, the called TN, and the IP address of the calling device 76, said return message also being routed over the messaging communications link 54. Interface device 60 determines the appropriate addressing associated with said called device 20 via its IP address, telephone number, or other identifier provided by said switching system 14. The interface device 60 relays the message from the switch 14 to the called device 20 via the wireless communications link, modem 72, and Ethernet link 34, said message including the IP address of the calling device 76. The called device 20, now having the IP address of the calling device 76, establishes a direct communication with the calling device over the Internet via its IP address.

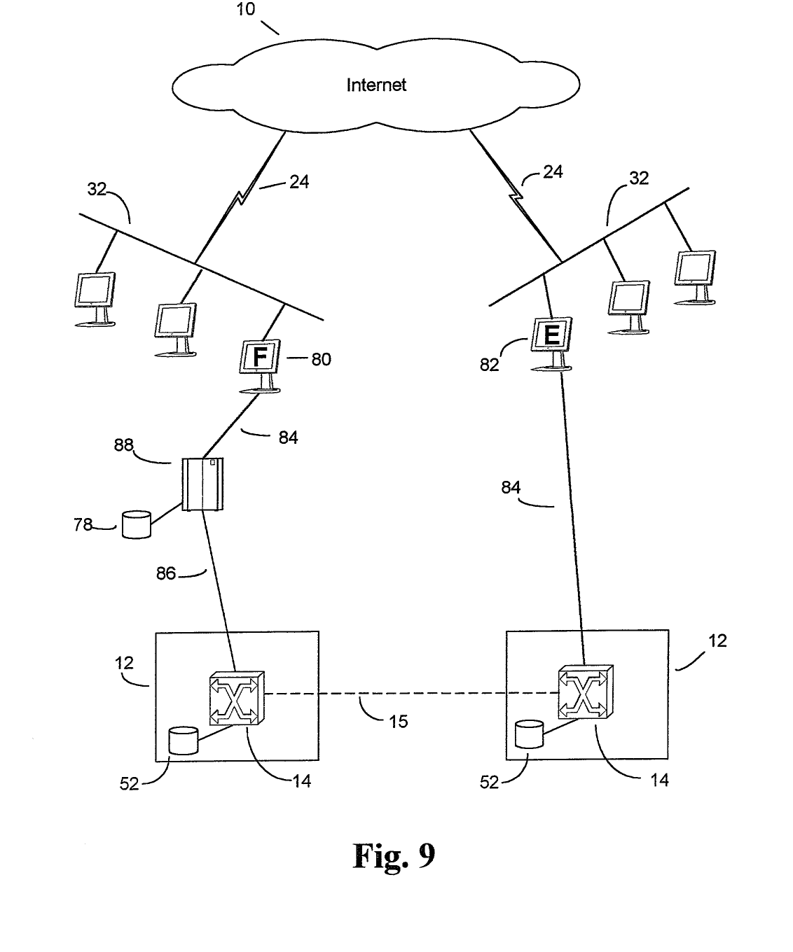

In yet another preferred embodiment, modern PBXs (Private Branch Exchange) and similar types of office telephone systems having a PSTN messaging capability as previously described could serve as a telco central office interface device for its client Integrated Device terminals by handling, forwarding, and otherwise processing the call setup, telephone number, and IP address messages used for establishing integrated Internet/telephony communications. In the context of this discussion, it should be understood that there could be surrogate systems, services, or devices that perform the cross-reference function as an agent or proxy on behalf of an individual device. For example, an ISDN PBX might maintain a cross-reference system 78 as shown in FIG. 9 for all of its Integrated Device workstations. Similarly, a server on a LAN might provide that service for all the Integrated Device workstations on a LAN.

Referring to FIG. 9, we see an implementation of an ISDN PBX and an ISDN telephone, the ISDN PBX being representative of messaging based office telephone systems. The Internet is shown as 10, and the PSTN is shown by two of its component C.O.'s 12, telephone switching systems 14, and messaging circuits 15 between them (there would also be voice trunking, not shown). Integrated Device workstation E shown as 82 is connected to a C.O. switch 14 by an ISDN BRI (Basic Rate Interface) connection 84. Central Office records system 52 maintains service records of telephone numbers and IP addresses for its subscriber devices such as Workstation E. Workstation E is also connected on a LAN 32 having an access line 24 to the Internet. ISDN PBX (Private Branch Exchange) 88 is connected to a C.O. switch 14 by an ISDN PRI (Primary Rate Interface) circuit 86, and has an Integrated Device workstation F shown as 80 connected to it via an ISDN BRI connection 84. ISDN BRI and PRI circuits multiplex voice and telephony digital messages on the same physical channel. Hence they can serve the required purpose of being capable of transporting messages necessary for integrating the Internet with the PSTN. ISDN PBX maintains its own service records 78 incorporating a TN to IP cross-reference for its client terminals such as workstation F. Workstation F is also connected to a LAN 32 having an access line 24 to the Internet. ISDN is a message oriented digital service comprised of both the capability of sending digital messages between devices and systems, and a suite of protocols to convey a structured set of information. For example, instead of sending tones for dialed digits to the C.O., and ISDN device sends a call setup request message to the C.O. containing the desired TN. If the call extends to another C.O., the local C.O. forwards the call setup message on to the remote C.O., and so on. Similarly, messages can extend through a PBX to its extension phones (in our case, an Integrated Device workstation). One aspect of the ISDN messaging system is the ability to send messages between end devices on a call.

By way of example to demonstrate the operation of this arrangement, presume that Integrated Device workstation F places a call to Integrated Device workstation E by sending a call setup message to PBX 88 using an ISDN messaging capability. The PBX 88 finds the IP address associated with Workstation F and forwards the call setup message with the IP address of the calling device on to the serving telco central office. The ISDN message travels across ISDN PRI access line 86, across the messaging communications link 15 between telco switching systems 14 to the serving telco central office for Workstation E. That telco central office sends a digital call setup message to Workstation E which includes the telephone number and IP address of Workstation F, said message being sent across the ISDN BRI link 84 to workstation E. Workstation E responds by sending an appropriate message via the Internet 10 to workstation F's IP address. Assuming that both devices agree to create the desired connection, an Internet connection is established and communication commences over the Internet.

Having thus described the invention in rather full detail, it will be understood that such detail need not be strictly adhered to, but that further changes and modifications may suggest themselves to one skilled in the art falling within the scope of the present invention as defined by the subjoined claims.

What is claimed is:

1. Apparatus for facilitating integration of the Internet with the Public Switched Telephone Network (PSTN) for telephone communications, comprising an interface device for providing Internet and telephony services to client devices capable of placing or receiving calls, and for providing an interface between said client devices and the PSTN, said interface device being provided with a messaging communications means to one or more elements of the PSTN, which messaging communications means carries call setup and call control messages to and from said elements of the PSTN, said call setup and call control messages including Internet Protocol (IP) address information of a calling or called device.

2. Apparatus for facilitating integration of the Internet with the PSTN for telephone communications as recited in claim 1, wherein said one or more elements of the PSTN comprise a telephone central office switching system, or an agent thereof.

3. Apparatus for facilitating integration of the Internet with the PSTN for telephone communications as recited in claim 1, further comprising means for said interface device to receive said call setup and call control messages from said client devices and to send said call setup and call control messages to said client devices.

4. Apparatus for facilitating integration of the Internet with the PSTN for telephone communications as recited in claim 1, wherein said messaging communications means connects to the PSTN SS7 network.

5. Apparatus for facilitating integration of the Internet with the PSTN for telephone communications as recited in claim 1, wherein said messaging communications means is provided by an Integrated Services Digital Network (ISDN) connection to the PSTN.

6. Apparatus for facilitating integration of the Internet with the PSTN for telephone communications as recited in claim 1, wherein said messaging communications means is the Internet.

7. Apparatus for facilitating integration of the Internet with the PSTN for telephone communications as recited by claim 1, wherein said interface device is adapted to provide a Voice over IP distribution service.

8. Apparatus for facilitating integration of the Internet with the PSTN for telephone communications as recited in claim 1, wherein said interface device is adapted to provide a DSL service.

9. Apparatus for facilitating integration of the Internet with the PSTN for telephone communications as recited in claim 1, wherein said interface device is adapted to provide telephony service via cable-TV.

10. Apparatus for facilitating integration of the Internet with the PSTN for telephone communications as recited in claim 1, wherein said interface device is adapted to provide wireless telephony service.

11. Apparatus for facilitating integration of the Internet with the PSTN for telephone communications as recited in claim 1, wherein said interface device is an office telephone system such as a PBX.

12. Apparatus for facilitating integration of the Internet with the PSTN for telephone communications as recited by claim 1, wherein said interface device functions as a telephone central office.

13. Apparatus for facilitating integration of the Internet with the PSTN for telephone communications as recited by claim 1, further comprising means for said interface device to maintain records of its client devices, said records including the telephone number and IP address of said client devices.

14. A method for facilitating integration of the Internet with the Public Switched Telephone Network (PSTN) for telephone communications, comprising the steps of:
(a) receiving a call setup request from a calling client device of an interface device by said interface device, said interface device providing Internet and telephony services to its client devices and providing an interface between said client devices and the PSTN; and
(b) sending a call setup request message to the PSTN by said interface device in response to said call setup request from said calling client device, said message including the called telephone number, an identifier of said calling client device such as a telephone number, and an Internet Protocol (IP) address of said calling client device.

15. A method for facilitating integration of the Internet with the Public Switched Telephone Network (PSTN) for telephone communications, comprising the steps of:
(a) receiving a call setup request from a calling client device of an interface device by said interface device, said interface device providing Internet and telephony services to its client devices and providing an interface between said client devices and the PSTN;
(b) sending a call setup request message to the PSTN by said interface device in response to said call setup request from said calling client device, said call setup request message including the telephone number of the called device, and an identifier of said calling client device such as a telephone number;
(c) receiving a message from the PSTN by said interface device in response to said call setup request message, said message from the PSTN to include an identifier of said calling device, and the Internet Protocol (IP) address of said called device; and
(d) sending a message to said calling device by said interface device in response to said message from the PSTN, said message to said calling device to include said IP address of said called device, whereby said calling device may initiate an Internet communication with said called device.

16. A method for facilitating integration of the Internet with the Public Switched Telephone Network (PSTN) for telephone communications, comprising the steps of:
(a) receiving a call setup request message from the PSTN by an interface device for a called client device of said interface device, said interface device providing Internet and telephony services to its client devices and providing an interface between said client devices and the PSTN, said call setup request message including an identifier of the calling device such as a telephone number, and an Internet Protocol (IP) address of said calling device; and
(b) sending a call setup request message to said called client device by said interface device in response to said call setup request message from the PSTN, said message to include an identifier of said calling device such as a telephone number, and an IP address of said calling device, whereby said called device may initiate an Internet communication with said calling device.
